(19) United States
(12) Patent Application Publication
(10) Pub. No.: US 2004/0024657 A1
(43) Pub. Date: Feb. 5, 2004

(54) Method, system and apparatus for providing product information over the internet

(75) Inventors: James Wright, Bolingbrook, IL (US); Klaus Drutschmann, Hiltpolstein (DE); Peter A. Luccarelli JR., New York, NY (US)

Correspondence Address: Siemens Corporation, Intellectual Property Department, 170 Wood Avenue South, Iselin, NJ, 08830, US

(73) Assignee: Siemens Energy & Automation

(21) Appl. No.: 10/411,642

(22) Filed: Apr. 11, 2003

Related U.S. Application Data
(62) Division of application No. 09/528,693, filed on Mar. 20, 2000.

(51) Int. Cl. G06F 17/60

(52) U.S. Cl. 705/27

(57) ABSTRACT

Product information is provided. An indicator that directs the customer to a web-page for the product information. The indicator may be disposed on a label affixed to the product. The indicator may be an URL to the web page. The label may be affixed in a prominent location on the product. The product information may be product specific. In another aspect, the indicator is stored in a memory. The indicator may be programmed into a programmable memory. The product may include a processor for accessing the indicator in memory and automatically establishing the interface between the customer and the web page. In yet another aspect, there is provided a place where the product information is stored that is easily accessed. The place where the product information is stored is easily updatable such as a web page.

### BACKGROUND

1. Field of the Invention

The present invention relates to providing product information and, more particularly, providing product information over the internet.

2. Related Information

It is essential to provide to the customer product information to install, operate and maintain the product. This is particularly important for industrial products that require experts to install and maintain them. Moreover, customer satisfaction greatly depends on the integrity of product information and it is the wise supplier who enlists product information as a vehicle to foster business relations.

It has always been a problem, however, to reliably communicate product information. The traditional method of supplying instruction manuals supplemented by updates has long been outmoded. Manuals and updates are cumbersome and laborious to read. They are also a notoriously slow means of communicating to the customer. Moreover, manuals are not user-friendly and hardly could be considered a vehicle for establishing business relations. From a cost perspective, manuals are expensive to both print and store.

More recently, the innovation of the telephone help desk seemed more promising. At least with the telephone, customers are updated more readily on product information. However, it was soon apparent that the telephone help desk frustrated customer relations with long waiting times, inconsistent technical help among different operators and the “take a number” feel of such help lines. The telephone help desk, if anything, proved to be more expensive due to the technical level required of the operators and the 24-hour nature of the service.

Underscoring the problems of the previous methods, there has been no satisfactory manner to provide product information for the life of the product. Further, the product information should be easily accesible in one convenient location. In addition, the product information needs to be easily updated. As an additional requirement, the product information should be product specific. Heretofore, there has been no means by which product information is communicated without the afore-mentioned problems.

### OBJECTS AND SUMMARY OF THE INVENTION

It is an object of the invention to provide product information.

It is another object of the invention to provide product information for the life of the product.

It is yet another object of the invention to provide product information easily and in one convenient location.

It is still another object of the invention to provide product information that is easily updated.

It is quite another object of the invention to provide product information that is product specific.

In accordance with the foregoing objectives, the present invention provides an indicator that directs the customer to a web-page for the product information. In one aspect, the indicator is disposed on a label affixed to the product. It is considered that the indicator is an URL to the web page. In at least one aspect, the label is affixed in a prominent location on the product. In a further aspect, the product information is product specific.

In another aspect of the invention, the indicator is stored in a memory provided with the product. In one aspect, the indicator is programmed into a programmable memory. In at least one aspect, it is provided that the product include a processor for accessing the indicator in memory and automatically establishing the interface between the customer and the web page.

In yet another aspect of the invention, there is provided a place where the product information is stored that is easily accessed. In another aspect, the place where the product information is stored is easily updatable. In yet another aspect, the place where the product information is stored is a web page.

### BRIEF DESCRIPTION OF THE DRAWINGS

FIG. 1 shows the label of the present invention;

FIG. 2 shows the memory of the present invention;

FIGS. 3a and 3b are flow diagrams of the operation of the present invention; and

FIG. 4 shows the web page of the present invention.

### DETAILED DESCRIPTION OF THE PREFERRED EMBODIMENTS

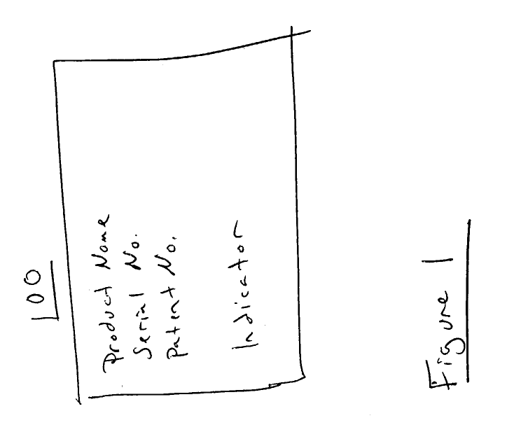

FIG. 1 shows the label 100 of the present invention. The indicator 102 is disposed on the label. Other product information 104 may be affixed on the label. The label 100 is affixed to the product 106 in a prominent position 108 where the customer is intended to notice the label. In one aspect of the invention, the indicator 102 is an URL for a web site.

The label 100, in one aspect, is affixed to the product in a prominent position such that the customer readily notices the label 100. The label 100 may be made of any material including an adhesive paper, metal tag, etc.

Indicator may be of any type including, for example, a bar code that is scanned in with, for example, a light wand (not shown). In one aspect, the bar code is translated into a web page address. The light wand may be part of a technician's utility pack (not shown) that is used to analyze the product.

The other information included may be that information which is typically found on a product label. This may include, for example, the product name, serial number, company, patent number, copyright, etc.

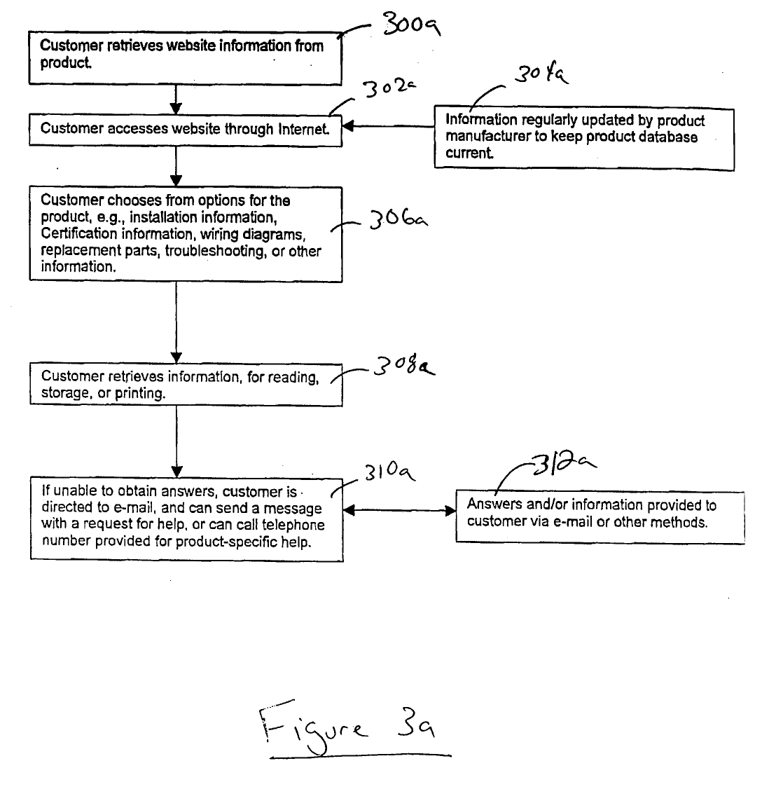

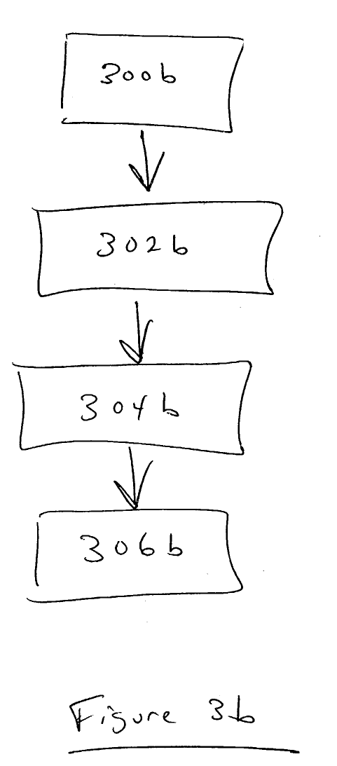

The operation shall now be described with reference to FIG. 3a wherein the customer retrieves the web site information (step S300a). The customer accesses the web site (step S302a). Information is regularly updated (step S304a). The customer chooses from options on the web site related to the product (step S306a). The customer retrieves the information (step S308a) for reading, storage or printing, for example. If the customer is unable to obtain answers, the customer may employ e-mail or request telephone assistance with contact information provided on the web page (step S310a). Such requests are answered (step S312a).

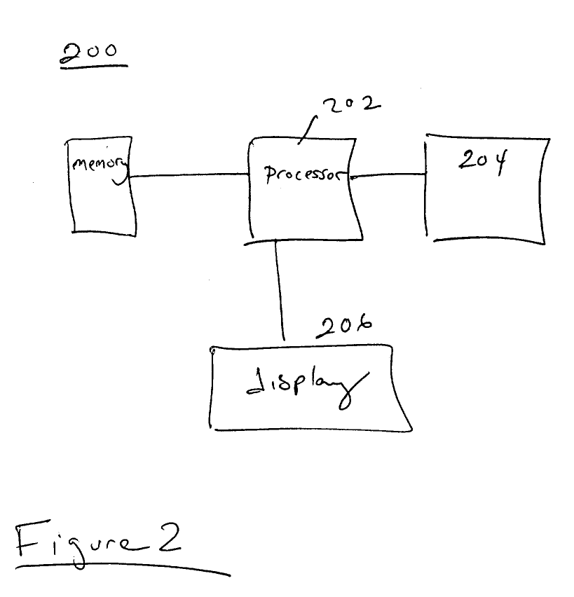

FIG. 2 shows the memory 200 of the present invention. In this aspect, the label is stored in the memory. There is also shown a processor 202 for accessing the memory 200 and an internet interface 204 for automatically interfacing to the internet using the label retrieved from the memory 200. A display 206 is provided for displaying the web page accessed using the label.

While the figure shows that the memory includes supporting devices such as a processor 202 and interface, the memory may be a stand-alone memory. For example, the memory may be micro-chip implanted in the product. The micro-chip may be accessible through a well-known type of port (not shown) such as a serial port. In one aspect, the micro-chip “piggy-back” on the port line where such is provided with the product.

In one aspect, the label stored in memory indicates the web page of the product information. This may be an URL. The memory may be a programmable memory or other equivalent storage means. This may include volatile, such as RAM or cache memory, or non-volatile memory, such as hard disk, CD-ROM, DVD or floppy, for example.

In an aspect of the invention, the interface is provided by a human/machine interface (HMI) such as that provided by Siemens. The HMI provides a software interface to industrial-type processors such as PLCs. In a variation of the HMI, an internet interface is provided that automatically interfaces to the internet using the label stored in memory 200.

A controller of particular relevance is described by Zavis et al. (U.S. Pat. No. 5,596,263 and U.S. Pat. No. 5,666,256) incorporated herein by reference.

In operation, and with reference to FIG. 3b, the processor 202 accesses the memory 200 (step S300b) to retrieve the label (step S302b). The processor 202 passes the label to the internet interface 204 (step S304b) and the internet interface automatically accesses the web page (step S306b).

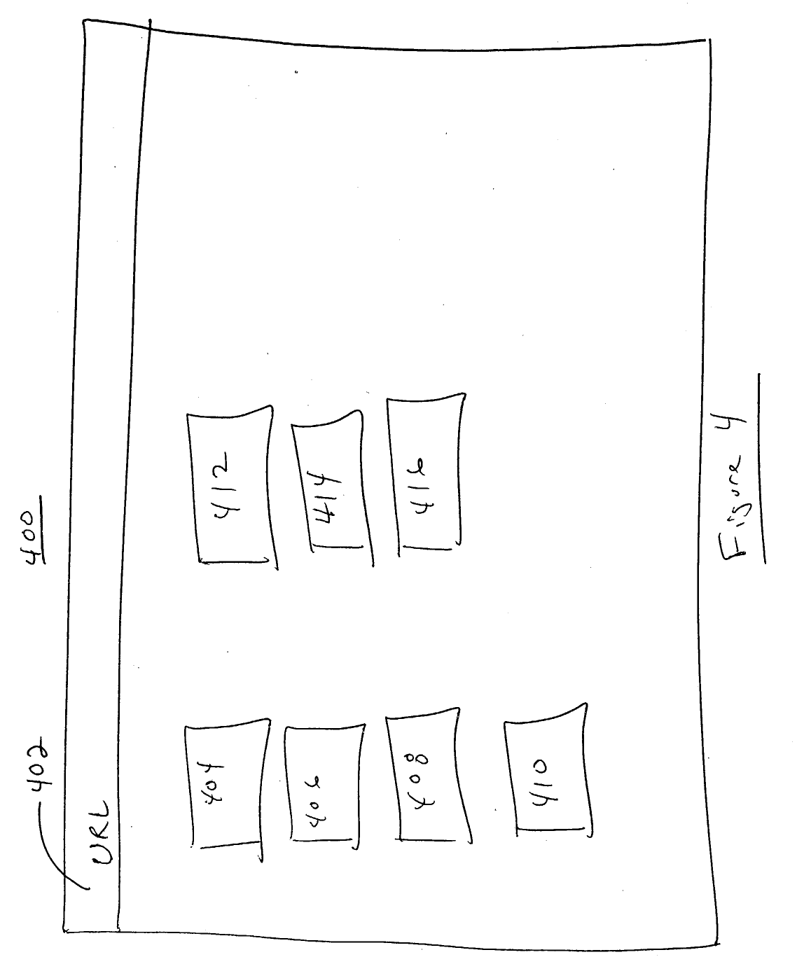

FIG. 4 shows the web page 400 of the present invention. There is shown an URL 402, product information 404, hypertext 406, other product information 408, a help window 410, a user's notes window 412, a password block 414 and alerts 416.

The web page of the present invention is described as an internet page. In addition, the page may be implemented in any on-line forum such as intranet or bulletin board system. The web page may be implemented in one of any of the well-known programming languages including HTML, JAVA or XML, for example, and one skilled in the art of computer programming will readily understand from the foregoing description how to implement the code necessary to form such a page.

In one aspect, the web page shown is specific to the product. In one arrangement, the URL of the web page is changed for each product such that the customer accesses the web page with specific information on that customer's product. For example, the product information may be specific due to maintenance history and schedules and is kept updated on the web page.

The product information 404 in an aspect of the invention includes, for example, product specifications 404a, installation documentation 404b, maintenance schedules 404c, maintenance log 404d, certification programs 404 e, etc. It is also an aspect to include a list of contact telephone numbers that allow the customer to contact live technicians.

Hypertext 406 is provided to allow the customer to instantly access related web pages. These may include links 406a to related sites on, for example, standards effecting the product, certification programs, regulatory agencies that promulgate rules according to laws that effect the product's use, etc. In one aspect, the hypertext is set to the precise web page relevant to the product. Thus, for example, a Profibus product, a well-known bus cable system, may have hypertext to the Profibus Standard web site, the web page for certifying technicians on Profibus and any regulatory industries effecting use of the bus.

In addition, the hypertext may be specific to each different product such that, for example, a particular customer's product is hyperlinked to web pages relating to that specific product. For example, a specific product may be having a unique problem and, in response, the hypertext is configured to send the customer to a special site that corrects such problems. In one aspect, the customer sets the hypertext using well-known web-page tools such as XML. In another aspect, the web page manager sets the hypertext based on specific experiences with the customer and the specific product. In this manner, each product may have its own custom-tailored web page.

The hypertext may also include a link to an e-mail function 406b. The e-mail link is set up to send e-mail directly to the technician responsible for handling the specific product. In one aspect, the e-mail is directed to a personal relations agent responsible for ensuring the customer's satisfaction. In another aspect, the personal relations agent may be copied automatically in order to provide quality assurance of the services rendered.

The other product information 408 may include, for example, installation information 408a, application information 408b, performance data 408c, testing information 408d or certification information 408e. The other product information may include a customer satisfaction questionare. Of course, additional information may be provided that relates to the product. This may include disclaimers, waivers or other legal information pertaining to the product.

In an aspect of the invention, a help window 410 is provided. In the help window, the customer, using well-known on-line “chat” technology, obtains instant access to a live technician. In one arrangement, the help window 410 includes a bar 410a that lists the technician's name and contact information (telephone number, e-mail, etc.) for easy reference. In one arrangement, the web page automatically updates the maintenance log with the dialog with the technician. In another arrangement, other communiques with the customer, such as telephone, are updated by the technician in the maintenance log. In this manner, the maintenance log is guaranteed to be a true reflection of the maintenance history of the specific product.

In another aspect, the web page may be custom tailored for each customer. The web page may includeany or all of the above components on one page such that the customer easily finds all information and resources on one easy-to-locate place. In one arrangement, one or more elements shown in FIG. 4 are provided in their own window on the web page such that the customer can scroll through the information according to each element on the same page. In one arrangement, the customer may edit and update the windows. For example, the customer may update the maintenance log to reflect maintenance on the product. In an aspect, the windows are expandable such that the customer can quickly select and expand any information needed. In yet another aspect, the windows may be dragged to different areas on the screen and the position saved. Also, the windows may be deleted. The ordinary web page designer will know how to implement these features. It will be appreciated that the ease of accessibility of this multiple window web page will greatly enhance customer satisfaction.

In still another aspect, the web page includes a customer's notes window 412. This window allows the customer to enter and edit notes on, for example, the product, maintenance or reminders, etc. The notes window 412 is automatically saved in order to preserve, in one convenient place, the customer's notes on the specific product.

The web page may include a password block 414 that requires the customer to enter a password to access and/or edit the web page. In one aspect, the password may be the serial number of the product. It will be appreciated that using the serial number of the product is very convenient for the customer as it allows the customer to be free from memorizing passwords for each product. At the same time, the serial number approach appears to be random enough to thwart most unauthorized accesses. In another aspect, further security is established by requiring the customer to enter a username. In one arrangement, an hierarchy of rights is created to, for example, read and, separately, to edit or write to the web page. In another aspect, the web page server generates a user log.

The web page includes alerts 416. The alerts, in one aspect, alert the customer to important information such as, for example, updates.

The web page of the present invention may be configured in any language or protocol to suit a number of devices. These may include Hot Link TM to interface with hand held devices, Cell Phone interfaces or utility belt interfaces. The advantages, particularly to the customer, are significant. The present invention provides product information for the life of the product. There is provided product information easily and in one convenient location. The product information is easily updated. In addition, the product information may product specific.

In addition to the advantages to the customer, the web page provides one convenient location for the supplier to update and maintain information on the specific product. In one aspect, the supplier edits and updates the web page information on the server. Since the web page is accessed by all cusomters, the supplier has tremendous control over the product information dispersed to the public. It will immediately be appreciated that this is of paramount significance because, for the first time, the supplier is able to prevent outdated information from circulating in the public domain. In addition, the supplier is able to update the information instantly. In one aspect, the web page alerts the customer to the updates, thereby ensuring that all customers are immediately apprised of the update. It will be appreciated that the present invention is an invaluable business tool by which the supplier more directly observes and controls the relationship with the customer.

We claim:

1. A product information apparatus for providing product information for a predetermined product, said apparatus comprising:
an indicator associated with said predetermined product coupled to said product; and
a web page indicated by said indicator associated with said predetermined product for providing said product information, wherein said indicator directs to said web page where said product information is provided for said predetermined product.

2. The apparatus of claim 1, wherein said indicator is specific to each product, such that a plurality of indictors that direct to a plurality of web pages are provided, each web page providing specific product information relevant to a specific product.

3. The apparatus of claim 1, wherein said indicator is an URL of a web page.

4. The apparatus of claim 1, further comprising a label affixed to said product, wherein said indicator is disposed on said label.

5. The apparatus of claim 1, further comprising a memory for storing said indicator, wherein said memory is provided with said product.

6. The apparatus of claim 5, further comprising means for automatically interfacing to the internet to access said web page based on said indicator.

7. A web page apparatus for providing product information for a predetermined product, said apparatus comprising:
a product information window for supplying said product information; and
a help window for providing on-line support for said product.

8. The apparatus of claim 7, wherein said help window includes a bar that indicates a name and contact information of an assistant that assists on said help window.

9. The apparatus of claim 8, further comprising a user notes window for providing a user with an area to record notes on said product.

10. The apparatus of claim 7, wherein said web page is product specific such that said web page relates to a particular product.

11. A method for providing product information, for providing product information for a predetermined product, said method comprising the steps of:
providing an indicator coupled to said product associated with said product information; and
connecting to a web page indicated by said indicator having said product information associated with said product information.

12. The method according to claim 11, further comprising the step of affixing a label to said product with said indicator disposed thereon.

13. The method according to claim 11, further comprising the step of providing said indicator as an URL of said web page.

14. The method according to claim 11, further comprising the step of storing said indicator in a memory provided with said product.

15. The method according to claim 11, further comprising the step of automatically accessing said web site in accordance with said indicator.

16. A method for providing product information, for providing product information for a predetermined product, said method comprising the steps of:
providing a web page having a product information window for providing said product information of said product; and
providing on said web page a help window for providing online support for said product.

17. The method of claim 16, wherein said step of providing a help window includes providing a bar that indicates a name and contact information of an assistant that assists on said help window.

18. The method of claim 16, further the step of providing a user notes window for providing a user with an area to record notes on said product.

19. The method of claim 16, further comprising the step of providing product specific such that said web page relates to a particular product.

20. The method of claim 16, further comprising the step of providing an alert window for alerting updates of said product information.
